(19) United States
(12) Patent Application Publication
(10) Pub. No.: US 2026/0281226 A1
(43) Pub. Date: Sep. 17, 2026

(54) MOBILE DEVICE HOLDER ASSEMBLY USING LIMITING MEMBER FOR ASSISTED ENGAGEMENT

(71) Applicant: Bone Collection Inc., Zhonghe City (TW)

(72) Inventor: Chin-Sheng LIN, New Taipei City (TW)

(21) Appl. No.: 19/210,281

(22) Filed: May 16, 2025

(30) Foreign Application Priority Data
Mar. 13, 2025 (TW) 114109403

(51) Int. Cl. H04M 1/04; F16B 2/08; F16M 13/02

(52) U.S. Cl. CPC H04M 1/04; F16B 2/08; F16M 13/022

(57) ABSTRACT

A mobile device holder assembly using a limiting member for assisted engagement includes a carrier base, snap base, and a securing element. The carrier base includes a carrier portion configured to carry a mobile device and at least one snap portion. The snap base includes a base body provided with a snap groove, a limiting member, an unlock member, and an elastic member. The snap groove has an edge that includes at least one snap area and at least one passage area configured to allow the snap portion to insert into the passage area and engage with the snap groove after rotating into the snap area. The limiting member is configured to, when in a limiting position, extend partially into the passage area for assisted engagement, and is configured to, when in an unlock position, retract partially from the passage area to release the assisted engagement.

### CROSS-REFERENCE TO RELATED APPLICATION

This application claims the priority benefit of Taiwan Patent Application No. 114109403, filed on Mar. 13, 2025. The entirety of the above-mentioned patent application is hereby incorporated by reference herein and made a part of the specification.

### BACKGROUND OF THE INVENTION

### Field of the Invention

The present invention generally relates to a mobile device holder assembly and, more particularly, to a mobile device holder assembly using a limiting member for assisted engagement.

### Description of the Related Art

In recent years, with the growing awareness of health and the widespread adoption of environmental protection concepts, bicycles have gradually become the preferred mode of transportation for daily commuting and leisure activities. This cycling trend not only reflects people's pursuit of a healthy lifestyle, but also highlights their increasing emphasis on environmental sustainability.

During bicycle riding, a smart phone has become an indispensable auxiliary tool. It can not only track various exercise data, such as riding distance, speed, and calories consumed, but also record exercise time, play music, and even provide real-time navigation to help riders find the optimal route.

To meet the demand for using a smart phone while riding a bicycle, the prior art technology has proposed a type of mobile device holder assembly that allows a smart phone to be mounted on a bicycle (or other carriers such as the human body or fitness equipment). The mobile device holder assembly typically includes a carrier base, snap base, and a securing element. In general, the rider first secures the smart phone to the carrier base. Then, the carrier base is removably assembled onto the snap base. Finally, the securing element is used to firmly attach the snap base onto the bicycle.

However, such mobile device holder assemblies in the prior art present certain design limitations. Specifically, to facilitate assembly and disassembly, the carrier base can typically only engage with the snap base in a specific orientation (for example, when the smart phone is placed vertically or horizontally). As a result, during riding, road bumps or vibrations from the bicycle may cause the carrier base to rotate and deviate from the original engagement orientation with the snap base, thereby increasing the risk of the smart phone falling off and being damaged.

### BRIEF SUMMARY OF THE INVENTION

In light of the prior art, where the carrier base can only engage with the snap base in a specific placement direction, there exists a risk that road bumps or vibrations from the bicycle may cause the carrier base to rotate, deviating from the original placement direction, and potentially resulting in the smart phone accidentally falling and becoming damaged.

The primary objective of the present invention is to provide a mobile device holder assembly using a limiting member for assisted engagement, which works by first inserting a snap portion of a carrier base into a passage area of a snap groove of the snap base, then rotating the snap portion to a snap area, and finally using a partial limiting member that extends into the passage area to prevent the snap portion from rotating back to the passage area, thereby preventing the snap portion from disengaging from the snap groove and solving the aforementioned problem.

Accordingly, the necessary technical means adopted by this invention to solve the problem of prior art is to provide a mobile device holder assembly using a limiting member for assisted engagement, configured to secure onto a carrier after securing a mobile device. The mobile device holder assembly includes a carrier base, a snap base, and a securing element.

The carrier base includes a carrier portion and at least one snap portion. The carrier portion is configured to carry and secure the mobile device. The at least one snap portion protrudes outward from one side of the carrier portion that faces away from the mobile device. Preferably, the carrier portion includes a carrier portion body and a securing structure. The carrier portion body is configured to carry mobile device. The securing structure extends outward from the carrier portion body and is configured to secure the mobile device onto the carrier portion body.

The snap base includes a base body, a limiting member, an unlock member, and an elastic member. The base body is provided with an accommodation space and a snap groove communicating with the accommodation space. The snap groove has an edge that includes at least one snap area and at least one passage area is configured to allow the at least one snap portion to insert into the at least one passage area and engage with the snap groove after rotating into the at least one snap area.

The limiting member is disposed within the accommodation space and configured to operably move between a limiting position and an unlock position. When in a limiting position, a portion of the limiting member extends from the accommodation space into the at least one passage area to prevent the at least one snap portion from rotating back from the at least one snap area to the at least one passage area. When in an unlock position, the portion of the limiting member retracts from the at least one passage area back into the accommodation space, to allow the at least one snap portion to disengage from the snap groove after rotating back from the at least one snap area to the at least one passage area. Preferably, the limiting member includes a limiting member body and at least one limiting wall. The limiting member body is disposed within the accommodation space. The at least one limiting wall protrudes from the limiting member body toward the at least one passage area.

The unlock member extends from outside the base body into the accommodation space and is operatively connected to the limiting member to move the limiting member from the limiting position to the unlock position when operated by an operating force. The elastic member is disposed within the accommodation space between the base body and the limiting member, and is configured to push the limiting member back to the limiting position after the operating force is released. Preferably, the unlock member is provided with at least one chamfered groove and the limiting member is provided with at least one inclined protrusion inserted into the at least one chamfered groove. The at least one inclined protrusion is configured so that the unlock member is operatively connected to the limiting member.

The securing element is secured to the snap base and configured to secure onto the carrier.

Based on the above necessary technical means, the following subsidiary technical means can be derived. Preferably, the base body includes a cap and a base. The cap is provided with the snap groove. The base is secured to the cap and configured to collectively define the accommodation space with the cap. More preferably, the base body further includes at least one buckling portion, and the securing element includes a securing element body and a carrier securing structure. The securing element body is provided with at least one buckling groove. The at least one buckling groove is configured to secure the securing element to the snap base after receiving the at least one buckling portion. The carrier securing structure extends from the securing element body in a direction away from the snap base and is configured to secure to the carrier, thereby securing the mobile device holder assembly to the carrier.

Based on the above necessary technical means, the following subsidiary technical means can be derived. Preferably, the snap base further includes a magnet. The magnet is disposed within the accommodation space and is configured to provide a magnetic force for mutual attraction with the carrier base.

In summary, the mobile device holder assembly using a limiting member for assisted engagement of the present invention works by first inserting a snap portion of a carrier base into a passage area of a snap groove of the snap base, then rotating the snap portion to a snap area, and finally using a partial limiting member that extends into the passage area to prevent the snap portion from rotating back to the passage area, thereby preventing the snap portion from disengaging from the snap groove and solving the aforementioned problem.

The embodiments employed in the present invention will be further illustrated by the following examples and accompanying drawings.

### BRIEF DESCRIPTION OF THE DRAWINGS

FIG. 1 is a perspective view of a mobile device holder assembly according to a preferred embodiment of the present invention;

FIG. 2 is a top view of a mobile device holder assembly according to a preferred embodiment of the present invention;

FIG. 3 is an exploded perspective view of a mobile device holder assembly according to a preferred embodiment of the present invention;

FIG. 4 is a perspective view of a carrier base according to a preferred embodiment of the present invention;

FIG. 5 is a perspective view of a carrier base after carrying and securing a mobile device according to a preferred embodiment of the present invention;

FIG. 6A and FIG. 6B are perspective views of a snap base according to a preferred embodiment of the present invention;

FIG. 7 is an exploded perspective view of a snap base according to a preferred embodiment of the present invention;

FIG. 8 is an exploded perspective view of a snap base from another angle according to a preferred embodiment of the present invention;

FIG. 9A and FIG. 9B are partially sectioned perspective views of a snap base according to a preferred embodiment of the present invention;

FIG. 10 is a perspective view of a snap portion before being inserted into a passage area according to a preferred embodiment of the present invention;

FIG. 11 is a perspective view of a snap portion during insertion into a passage area according to a preferred embodiment of the present invention;

FIG. 12 is a perspective view of a snap portion after being rotated into a snap area according to a preferred embodiment of the present invention;

FIG. 13 is a perspective view of a mobile device holder assembly secured onto a carrier with a snap portion located in a passage area according to a preferred embodiment of the present invention; and

FIG. 14 is a perspective view of a mobile device holder assembly secured onto a carrier with a snap portion located in a snap area according to a preferred embodiment of the present invention.

### DETAILED DESCRIPTION OF THE EMBODIMENTS

The mobile device holder assembly using a limiting member for assisted engagement provided by the present invention may be implemented in various different embodiments, which will not all be described in detail here. Only one preferred embodiment is illustrated and described in detail to clearly demonstrate the objectives and advantages of the invention. This embodiment is merely provided to facilitate a better understanding of the present invention.

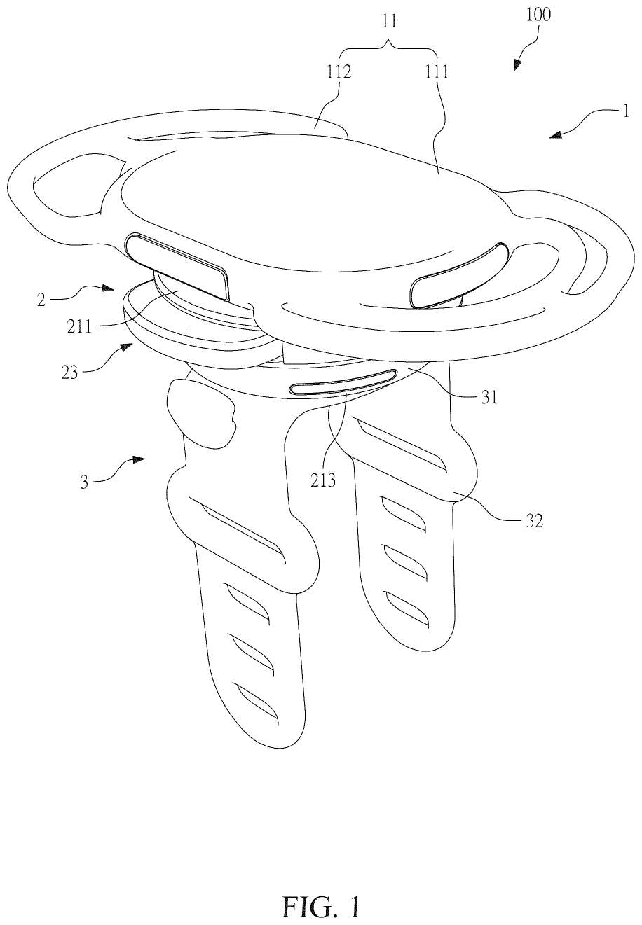

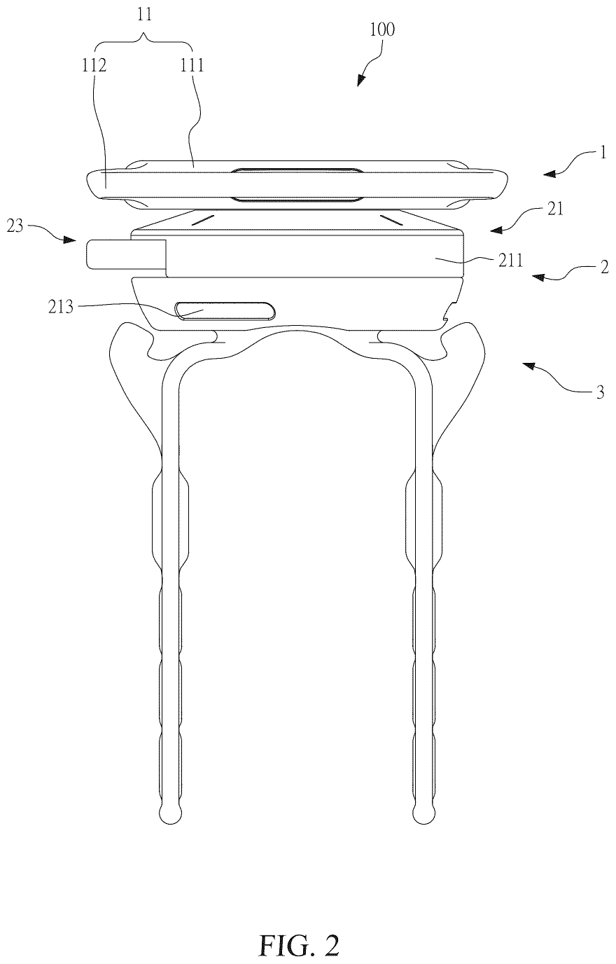

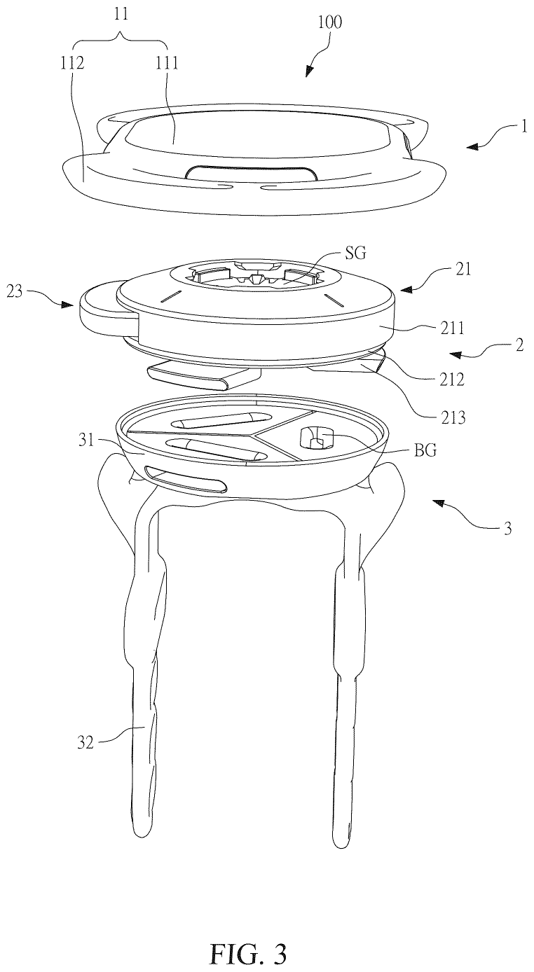

Please refer to FIG. 1 to FIG. 3, where FIG. 1 is a perspective view of a mobile device holder assembly according to a preferred embodiment of the present invention; FIG. 2 is a top view of a mobile device holder assembly according to a preferred embodiment of the present invention; and FIG. 3 is an exploded perspective view of a mobile device holder assembly according to a preferred embodiment of the present invention.

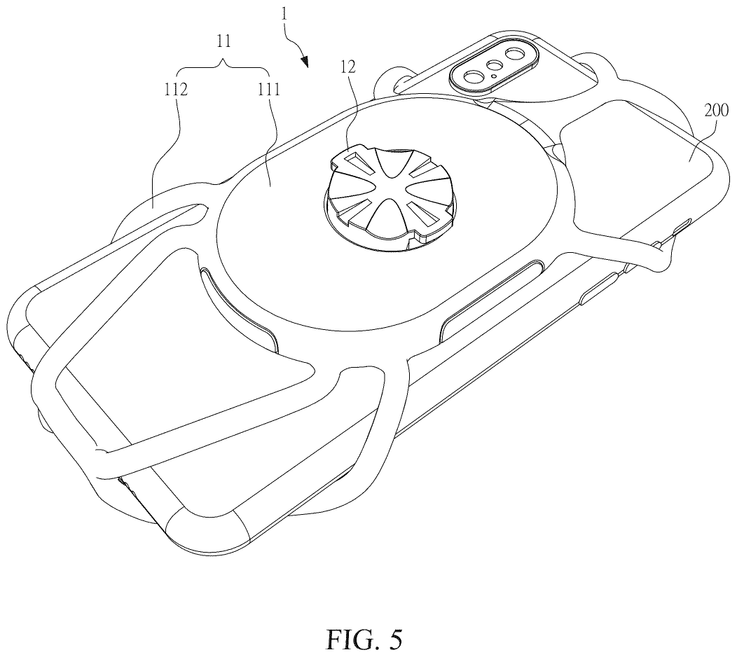

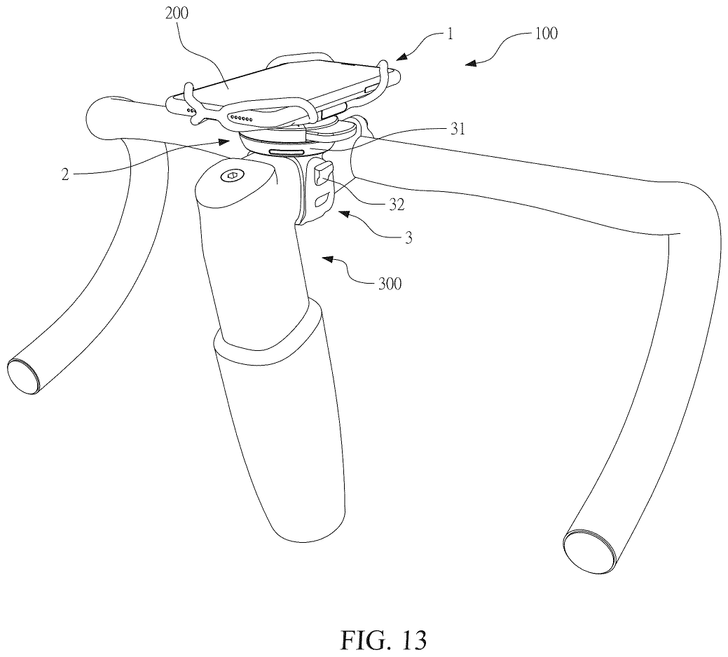

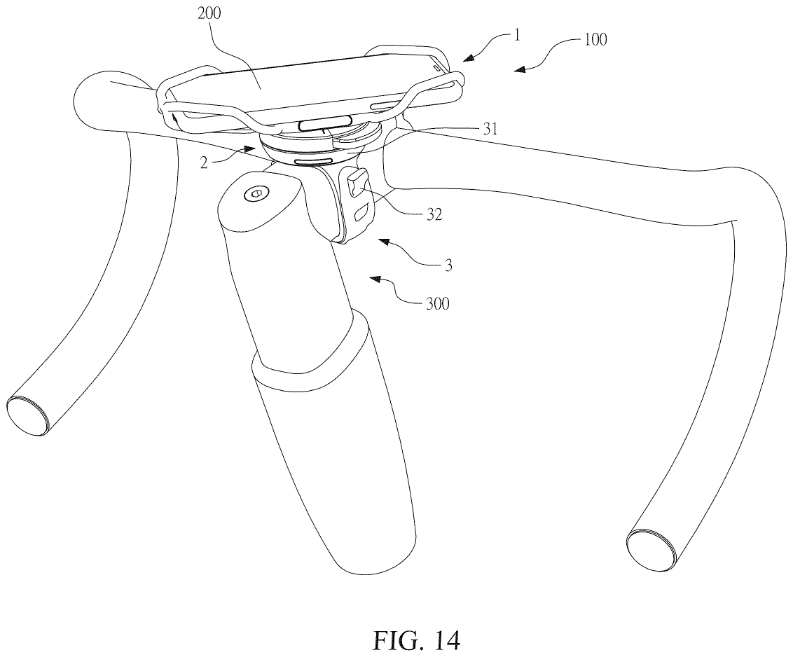

As shown in FIG. 1 to FIG. 3, a mobile device holder assembly using a limiting member for assisted engagement (hereinafter referred to as “mobile device holder assembly”) 100 is configured to secure onto a carrier 300 (shown in FIG. 13 and FIG. 14) after securing a mobile device 200 (shown in FIG. 5).

In this embodiment, the mobile device 200 is a smart phone, but is not limited to this. In other embodiments, the mobile device 200 can be, for example, a portable music player, a navigation device, a tablet computer, or even a water bottle or other device that would be carried while on the move.

In this embodiment, the carrier 300 is a bicycle (for example, the support post or the handlebar), but is not limited to this. In other embodiments, the carrier 300 may be, for example, a human body part (such as an arm), fitness equipment, etc.

Structurally, the mobile device holder assembly 100 includes a carrier base 1, a snap base 2, and a securing element 3.

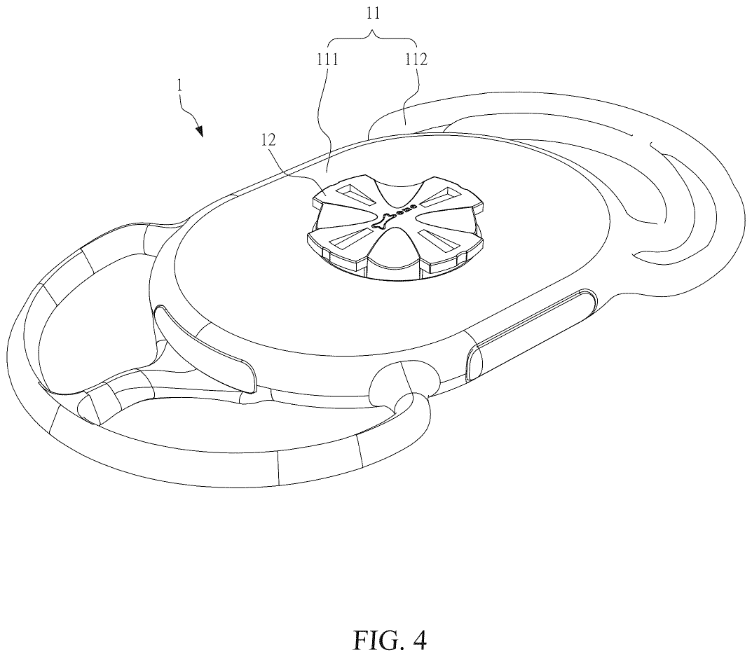

Please further refer to FIG. 4 and FIG. 5, where FIG. 4 is a perspective view of a carrier base according to a preferred embodiment of the present invention and FIG. 5 is a perspective view of a carrier base after carrying and securing a mobile device according to a preferred embodiment of the present invention.

As shown in FIG. 4 and FIG. 5, the carrier base 1 includes a carrier portion 11 and at least one snap portion. In this embodiment, the carrier base 1 includes four snap portions 12 (only one of which is labeled), but is not limited to this. In other embodiments, there may be only one snap portion 12 or other quantities of snap portions 12.

The carrier portion 11 is configured to carry and secure the mobile device 200. The snap portion 12 protrudes outward from one side of the carrier portion 11 that faces away from the mobile device 200. In this embodiment, the carrier portion 11 includes a carrier portion body 111 and a securing structure 112. The carrier portion body 111 is configured to carry the mobile device 200. The securing structure 112 extends outward from the carrier portion body 111 and is configured to secure the mobile device 200 onto the carrier portion body 111. In this embodiment, the securing structure 112 includes elastic binding cords configured to wrap around and secure the mobile device 200, but is not limited to this. In other embodiments, the securing structure 112 may utilize magnetic attraction, buckles, clamping, or other securing methods to secure the mobile device 200.

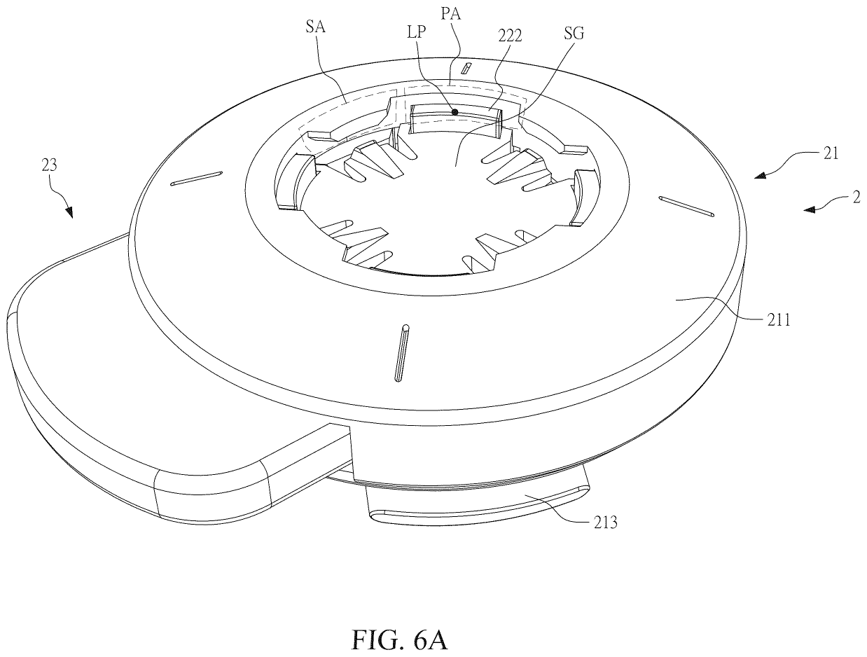

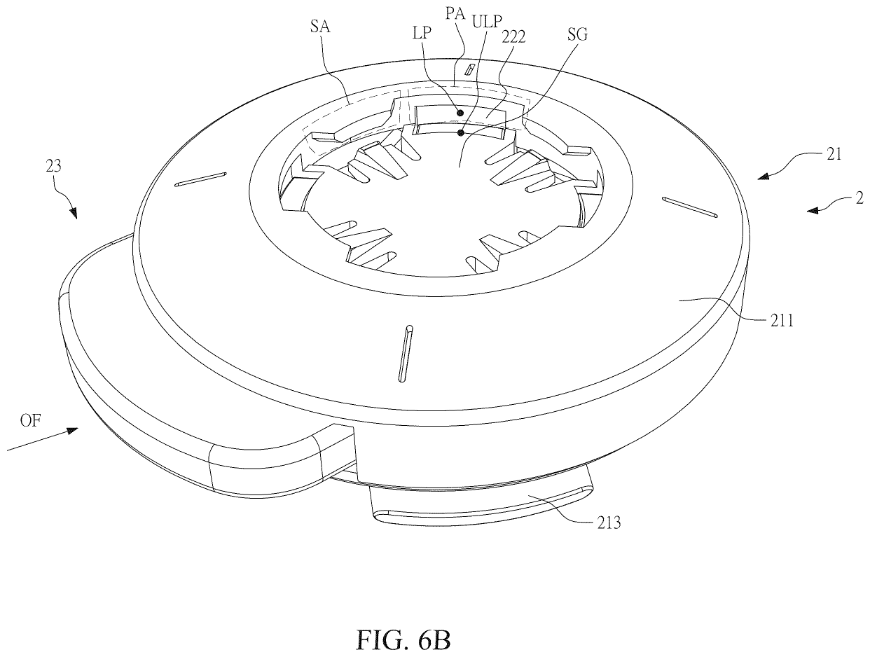

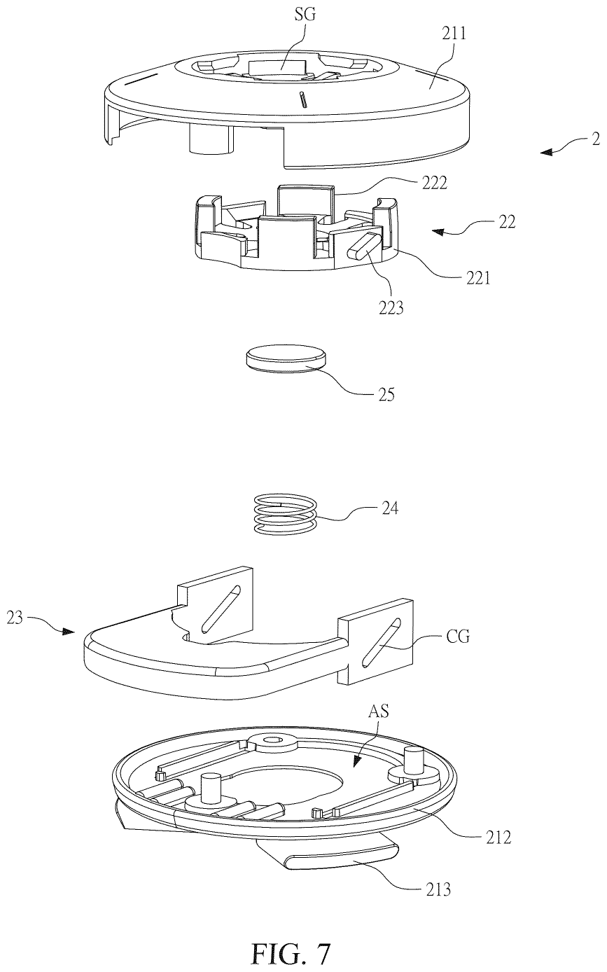

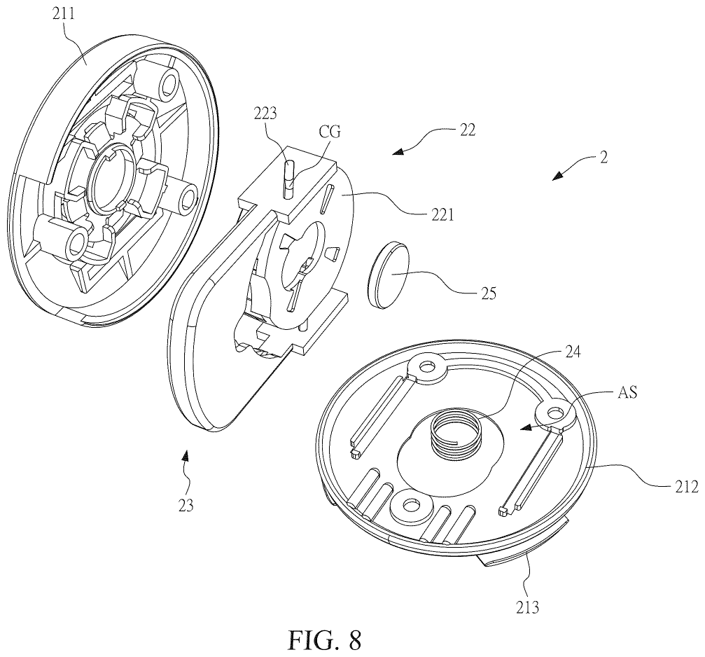

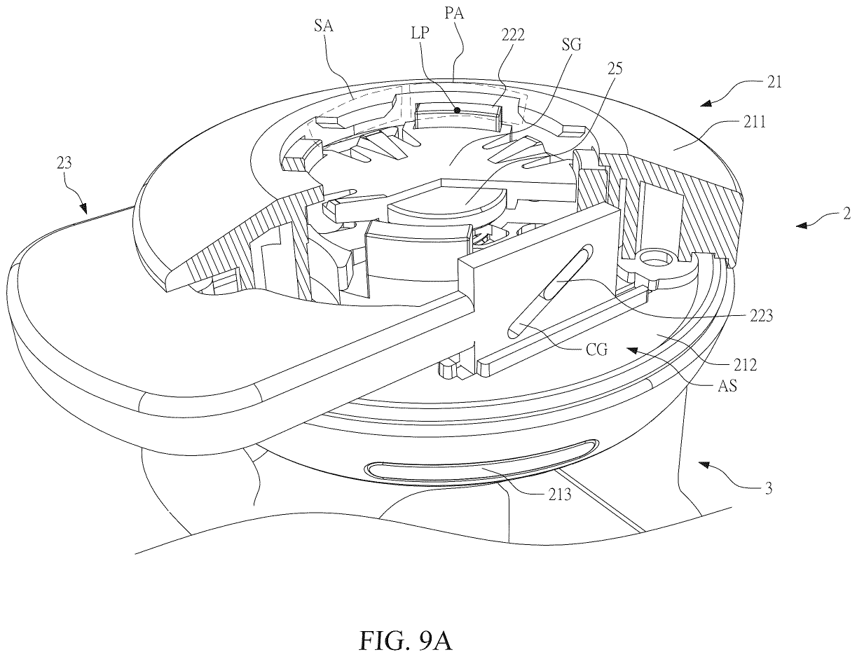

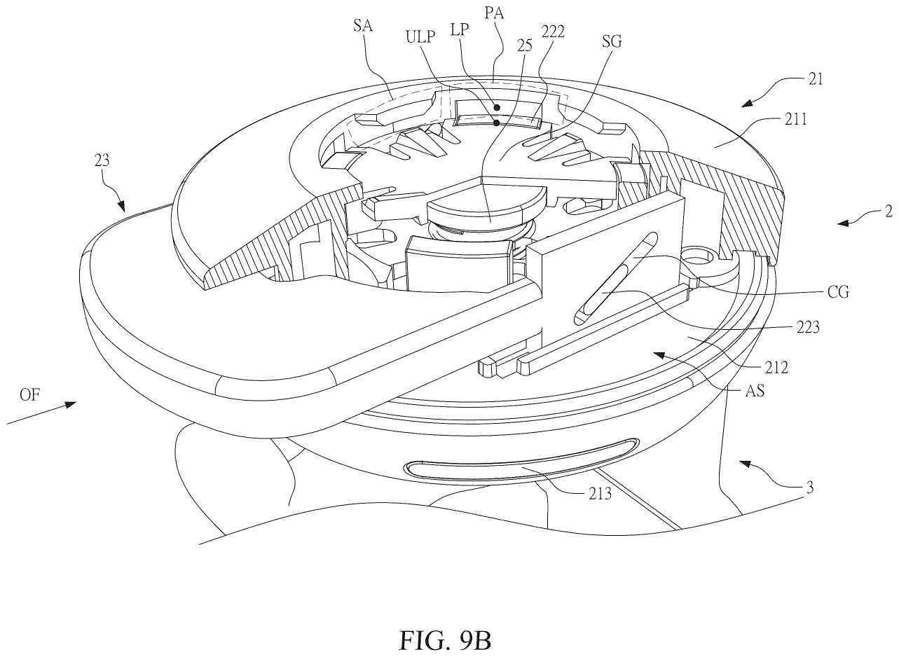

Please further refer to FIG. 6A to FIG. 9B. where FIG. 6A and FIG. 6B are perspective views of a snap base according to a preferred embodiment of the present invention; FIG. 7 is an exploded perspective view of a snap base according to a preferred embodiment of the present invention; FIG. 8 is an exploded perspective view of a snap base from another angle according to a preferred embodiment of the present invention; and FIG. 9A and FIG. 9B are partially sectioned perspective views of a snap base according to a preferred embodiment of the present invention.

As shown in FIG. 6A through FIG. 9B, the snap base 2 includes a base body 21, a limiting member 22, an unlock member 23, and an elastic member 24. The base body 21 is provided with an accommodation space AS and a snap groove SG communicating with the accommodation space AS. In this embodiment, the base body 21 includes a cap 211 and a base 212. The cap 211 is provided with the snap groove SG. The base 212 is secured to the cap 211 and configured to collectively define the accommodation space AS together with the cap 211.

The snap groove SG has an edge that includes at least one snap area and at least one passage area configured. In this embodiment, the edge of the snap groove SG includes a total of four snap areas SA (only one of which is labeled) and four passage areas PA (only one of which is labeled), corresponding to the quantity of snap portions 12. In other words, each snap portion 12 corresponds to one snap area SA and one passage area PA.

After the snap portion 12 is inserted into the passage area PA and rotated to the snap area SA, it engages with the snap groove SG. In this embodiment, the difference between the snap area SA and the passage area PA is that the snap area SA is provided with a plurality of snap protrusions (not labeled in the figure), some of which are formed on the bottom wall and others on the side wall of the snap groove SG. These protrusions are configured to interlock with the snap portion 12, but are not limited to this. In other embodiments, the interlocking may be achieved, for example, through snap recesses that interlock with the snap portion 12.

The limiting member 22 is disposed within the accommodation space AS and configured to operably move between a limiting position LP and an unlock position ULP. When in a limiting position LP, a portion of the limiting member 22 extends from the accommodation space AS into the at least one passage area PA to prevent the at least one snap portion 12 from rotating back from the at least one snap area SA to the at least one passage area PA. When in an unlock position ULP, the portion of the limiting member 22 retracts from the at least one passage area PA back into the accommodation space AS, to allow the at least one snap portion 12 to disengage from the snap groove SG after rotating back from the at least one snap area SA to the at least one passage area PA.

In this embodiment, the limiting member 22 includes a limiting member body 221 and four limiting walls 222 (where only one is labeled) corresponding to the quantity of passage areas PA. That is to say, each limiting wall 222 corresponds to one passage area PA. The limiting member body 221 is disposed within the accommodation space AS. The limiting wall 222 protrudes from the limiting member body 221 toward the at least one passage area PA so as to extend into the passage area PA when the limiting member 22 is in the limiting position LP and withdraw from the passage area PA when the limiting member 22 is in the unlock position ULP.

The unlock member 23 extends from outside the base body 21 into the accommodation space AS and operatively connected to the limiting member 22 to move the limiting member 22 from the limiting position LP to the unlock position ULP when operated by an operating force OF (for example, when pressing the unlock member 23). In this embodiment, to transmit force, the unlock member 23 is provided with at least one chamfered groove and the limiting member 22 is provided with at least one inclined protrusion inserted into the at least one chamfered groove so that the unlock member 23 is operatively connected to the limiting member 22.

In this embodiment, unlock member 23 is provided with two chamfered grooves CG (only one of which is labeled), and the limiting member 22 is provided with two inclined protrusions 223 (only one of which is labeled) that insert into the chamfered grooves CG. When the unlock member 23 is operated by the operating force OF, the inclined protrusions 223 slide within the chamfered grooves CG, thereby allowing the limiting member 22 to move from the limiting position LP to the unlock position ULP. In other embodiments, other force transmission structures (such as gears) may be used. Additionally, the reason for adopting an inclined design is to change the direction of force. Specifically, it can convert horizontal force into vertical force, so that when operating the unlock member 23 horizontally, the limiting member 22 can move vertically.

The elastic member 24 is disposed within the accommodation space AS between the base body 21 and the limiting member 22, and is configured to push the limiting member 22 back to the limiting position LP after the operating force is released. In this embodiment, elastic member 24 is a spring, but is not limited to this. In other embodiments, the elastic member 24 may be, for example, a spring sheet or other elastic object.

To enhance the stability during engagement, the snap base 2 further includes a magnet 25. The magnet 25 is disposed within the accommodation space AS and is configured to provide a magnetic force (not shown) for mutual attraction with the carrier base 1. Practically, to make the carrier base 1 attracted by the magnet 25, the carrier base 1 may be made of magnet-attractable materials (such as ferrous metal), or components that can be attracted by magnets (such as another magnet or iron element) may be embedded within the carrier base 1. In this embodiment, the magnet 25 is embedded in the bottom wall of the snap groove SG, but is not limited thereto.

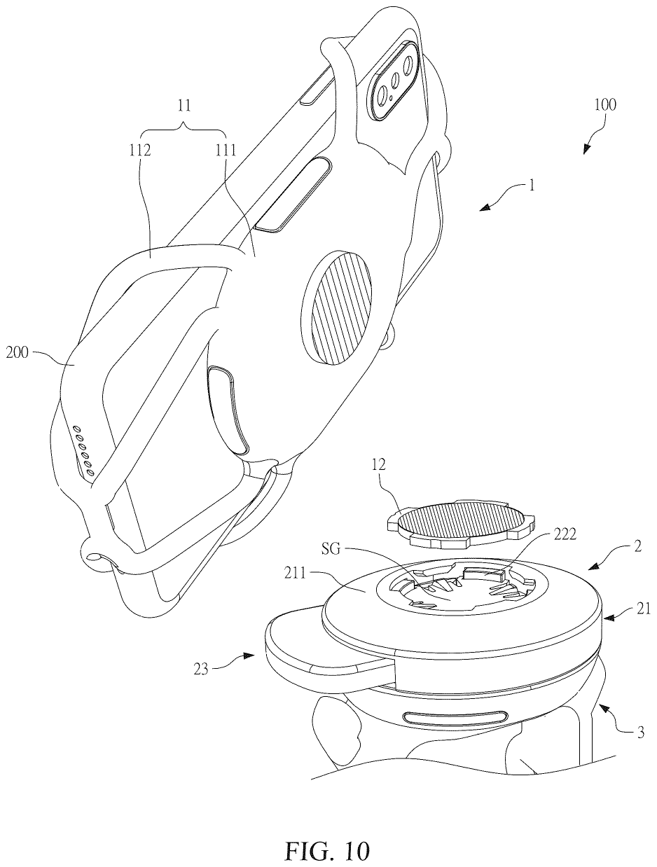

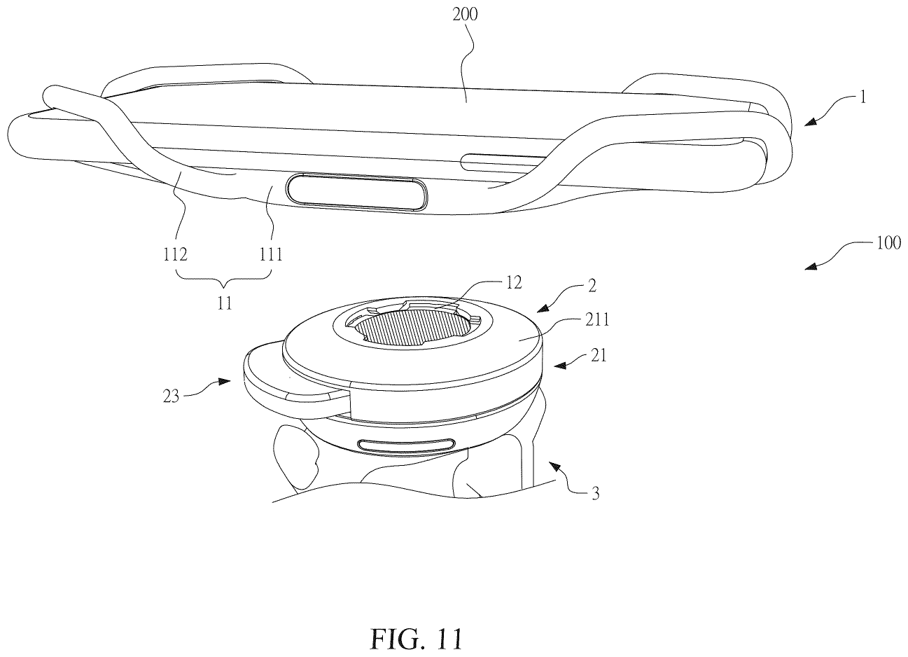

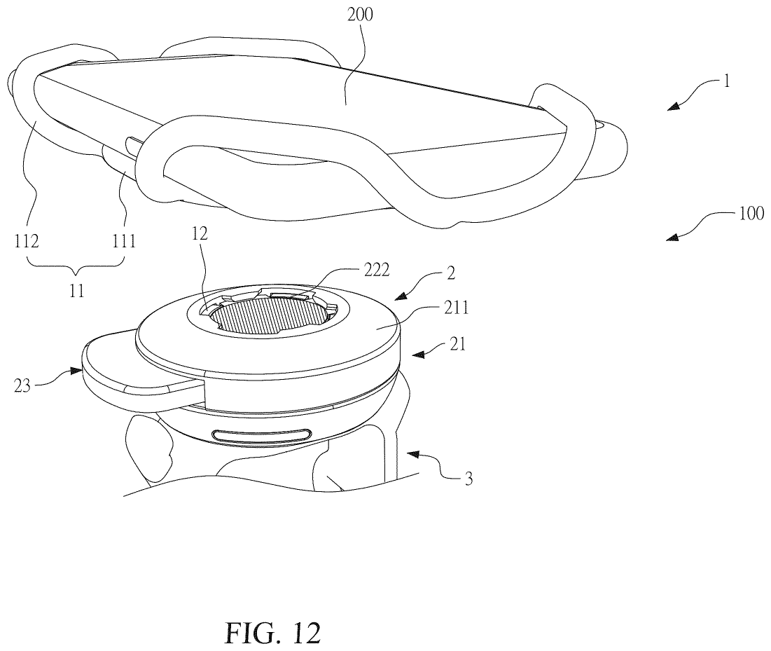

Please refer to FIG. 10 to FIG. 14, where FIG. 10 is a perspective view of a snap portion before being inserted into a passage area according to a preferred embodiment of the present invention; FIG. 11 is a perspective view of a snap portion during insertion into a passage area according to a preferred embodiment of the present invention; FIG. 12 is a perspective view of a snap portion after being rotated into a snap area according to a preferred embodiment of the present invention; FIG. 13 is a perspective view of a mobile device holder assembly secured onto a carrier with a snap portion located in a passage area according to a preferred embodiment of the present invention; and FIG. 14 is a perspective view of a mobile device holder assembly secured onto a carrier with a snap portion located in a snap area according to a preferred embodiment of the present invention.

As shown in FIG. 10 to FIG. 14, the mobile device holder assembly 100 with the mobile device 200 secured thereto is secured onto a carrier 300 via the securing element 3. Structurally, the securing element 3 is secured to the snap base 2 and is configured to secure onto a carrier 300. In this embodiment, the base body 21 further includes at least one buckling portion, and the securing element 3 includes a securing element body 31 and a carrier securing structure 32.

The securing element body 31 is provided with at least one buckling groove, which is configured to allow the at least one buckling portion to be inserted, thereby securing the securing element 3 to the snap base 2. In this embodiment, there are three buckling portions 213 (only one of which labeled) and three buckling grooves BG (only one of which labeled).

The carrier securing structure 32 extends from the securing element body 31 in a direction away from the snap base 2 and is configured to secure to the carrier 300, thereby securing the mobile device holder assembly 100 to the carrier 300. In this embodiment, the carrier securing structure 32 is a strap, but not limited thereto. In other embodiments, the carrier securing structure 32 may be, for example, a buckle, clamp, or lock. In other embodiments, the securing element 3 may be secured to the snap base 2 by other means, such as being integrally formed with the snap base 2.

Next, the assembly sequence will be described. It should be noted that, in order to illustrate the rotational relationship between the snap portion 12 and the carrier portion 11 (the mobile device 200), the carrier base 1 is sectioned in FIG. 10 to FIG. 12. In reality, there is no cross-section between the snap portion 12 and the carrier portion 11.

The user (for example, a rider) first secures the mobile device 200 (for example, a smart phone) to the carrier portion 11, and then aligns the snap portion 12 with the passage area PA and inserts the snap portion 12 into the passage area PA. At this point, the mobile device 200 is placed in an inclined position (relative to vertical or horizontal orientation, as shown in FIG. 13). It should be noted that since the elastic member 24 pushes against the limiting member 22, causing the limiting member 22 to be preset in the limiting position LP. At this point, part of the limiting member 22 (the limiting wall 222) extends into the passage area PA. Therefore, when inserting the snap portion 12 into the passage area PA, a force greater than the elastic force generated by the elastic member 24 must be applied to press the limiting wall 222 back into the accommodation space AS.

Then, the mobile device 200 (the carrier base 1) is rotated so that the snap portion 12 is rotated into the snap area SA and engages with the snap groove SG. At this point, the limiting wall 222 re-extends into the passage area PA to prevent the snap portion 12 from rotating back, thereby preventing disengagement from the snap groove SG. Meanwhile, the mobile device 200 is vertically or horizontally positioned, making it convenient for the user to operate.

Conversely, to remove the mobile device 200 (the carrier base 1), the user only needs to apply an operating force OF to press the unlock member 23, which moves the limiting member 22 from the limiting position LP to the unlock position ULP. At this point, the limiting wall 222 retracts into the accommodation space AS, allowing the mobile device 200 (the carrier base 1) to be rotated. After rotating the snap portion 12 to the passage area PA, the engagement with the snap groove SG is released, enabling removal.

In summary, the mobile device holder assembly 100 of the present invention works by first inserting a snap portion 12 of a carrier base 1 into a passage area PA of the snap groove SG of a snap base 2, then rotating the snap portion 12 to a snap area SA, and finally using a partial limiting member 22 that extends into the passage area PA to prevent the snap portion from rotating back to the passage area PA, thereby preventing the snap portion 12 from disengaging from the snap groove SG and solving the aforementioned problem.

Through the detailed descriptions of the above preferred embodiments, the purpose is to more clearly illustrate the features and spirit of the present invention, rather than to limit its scope to the disclosed preferred embodiments. On the contrary, the intent is to encompass various modifications and equivalent arrangements within the scope of the patent claims for which the present invention seeks protection.

1. A mobile device holder assembly using a limiting member for assisted engagement, configured to secure onto a carrier after securing a mobile device, the mobile device holder assembly comprising:
a carrier base, comprising:
a carrier portion configured to carry and secure the mobile device; and
at least one snap portion protruding outward from one side of the carrier portion that faces away from the mobile device;
a snap base, comprising:
a base body provided with an accommodation space and a snap groove communicating with the accommodation space, the snap groove having an edge that comprises at least one snap area and at least one passage area configured to allow the at least one snap portion to insert into the at least one passage area and engage with the snap groove after rotating into the at least one snap area;
a limiting member disposed within the accommodation space and configured to operably move between a limiting position and an unlock position, wherein, when in the limiting position, a portion of the limiting member extends from the accommodation space into the at least one passage area to prevent the at least one snap portion from rotating back from the at least one snap area to the at least one passage area, and, when in the unlock position, the portion of the limiting member retracts from the at least one passage area back into the accommodation space, to allow the at least one snap portion to disengage from the snap groove after rotating back from the at least one snap area to the at least one passage area;
an unlock member extending from outside the base body into the accommodation space and operatively connected to the limiting member to move the limiting member from the limiting position to the unlock position when operated by an operating force; and
an elastic member disposed within the accommodation space between the base body and the limiting member, and configured to push the limiting member back to the limiting position after the operating force is released; and
a securing element secured to the snap base and configured to secure onto the carrier.

2. The mobile device holder assembly of claim 1, wherein the carrier portion comprises:
a carrier portion body configured to carry the mobile device; and
a securing structure extending outward from the carrier portion body and configured to secure the mobile device onto the carrier portion body.

3. The mobile device holder assembly of claim 1, wherein the limiting member comprises:
a limiting member body disposed within the accommodation space; and
at least one limiting wall protruding from the limiting member body toward the at least one passage area.

4. The mobile device holder assembly of claim 1, wherein the unlock member is provided with at least one chamfered groove and the limiting member is provided with at least one inclined protrusion inserted into the at least one chamfered groove, wherein the at least one inclined protrusion is configured so that the unlock member is operatively connected to the limiting member.

5. The mobile device holder assembly of claim 1, wherein the base body comprises:
a cap provided with the snap groove; and
a base secured to the cap and configured to collectively define the accommodation space with the cap.

6. The mobile device holder assembly of claim 5, wherein the base body further comprises at least one buckling portion and the securing element comprises:
a securing element body provided with at least one buckling groove, the at least one buckling groove being configured to secure the securing element to the snap base after receiving the at least one buckling portion; and
a carrier securing structure extending from the securing element body in a direction away from the snap base and configured to secure to the carrier, thereby securing the mobile device holder assembly to the carrier.

7. The mobile device holder assembly of claim 1, wherein the snap base further comprises a magnet disposed within the accommodation space and configured to provide a magnetic force for mutual attraction with the carrier base.
